(19) United States
(12) Patent Application Publication
(10) Pub. No.: US 2011/0242411 A1
(43) Pub. Date: Oct. 6, 2011

(54) Method And System For Minimizing Signals For Video Data Communication

(76) Inventors: Bernhard AUER, Enns (AT); Juergen HAAS, Marchtrenk (AT); Manfred MEINDL, Linz (AT); Andreas WASSERBAUER, Pettenbach (AT)

(21) Appl. No.: 12/749,620

(22) Filed: Mar. 30, 2010

(51) Int. Cl. H04N 5/04; H04N 5/38

(52) U.S. Cl. 348/500; 348/723; 348/E05.093

(57) ABSTRACT

A system for minimizing signals for video data communication is provided. The system comprises a first interface for selecting at least one video signal for transmission via a video data vector based on a data enable signal and a second interface for outputting at least one video signal from the video data vector based on the data enable signal.

### TECHNICAL FIELD

The present invention relates generally to video data communications. In particular, the present disclosure relates to minimizing signals for video data communication.

### BACKGROUND

Semiconductor devices are used in everyday life and applications include automotive, industry, and audio video. Video interfaces, such as interfaces between a camera module and a processor or between a processor and a display module, typically require a large number of signals for data communications. Such requirement waste resources on all levels of a system, including resources on an integrated circuit die, an integrated circuit package, a printed circuit board, and connections and cables of the system. It also affects the size of the overall end product. Therefore, a need exists for a method and system to minimize the number of signals for the input/output of video data.

### BRIEF DESCRIPTION OF DRAWINGS

FIG. 1A is a diagram of an exemplary system for transmitting and receiving video data signals in accordance with one embodiment of the present disclosure.

FIG. 1B is a diagram of an exemplary system for transmitting and receiving video data signals in accordance with an alternative embodiment of the present disclosure.

FIG. 2 is a timing diagram of an exemplary interface before time multiplexing in accordance with one embodiment of the present disclosure.

FIG. 3 is a diagram illustrating an exemplary interface for multiplexing video data in accordance with one embodiment of the present disclosure.

FIG. 4 is a timing diagram of an exemplary interface for multiplexing video data in accordance with an alternative embodiment of the present disclosure.

FIG. 5 is a timing diagram of an exemplary interface after time multiplexing in accordance with one embodiment of the present disclosure.

FIG. 6 is a diagram illustrating an exemplary interface for de-multiplexing video data in accordance with one embodiment of the present disclosure.

FIG. 7 is a flowchart of an exemplary process for time multiplexing of input signals of video data in accordance with one embodiment of the present disclosure.

FIG. 8 is a flowchart of an exemplary process for time demultiplexing of input signals of video data in accordance with one embodiment of the present disclosure.

### SUMMARY OF INVENTION

The present disclosure provides a system for minimizing signals for video data communication. The system comprises a first interface for selecting at least one video signal for transmission via a video data vector based on a data enable signal, and a second interface for outputting at least one video signal from the video data vector based on the data enable signal.

In one embodiment, the present disclosure provides a video interface comprising a multiplexer for selecting at least one video signal to transmit via a video data vector upon detecting a data enable signal. In another embodiment, the present disclosure provides a video interface comprising a de-multiplexer for outputting at least one video signal from a video data vector upon detecting a data enable signal.

In yet another embodiment, the present disclosure provides a method for minimizing signals for video data communications comprising detecting at least one video input signal comprising at least one synchronization signal and at least one video data, and transmitting one of the at least one synchronization signal and the at least one actual video data via a video data vector based on a data enable signal.

### DETAIL DESCRIPTION

Many of the various disclosed embodiments relate to an apparatus including a video interface and further including time multiplexer and de-multiplexer devices within the video interface and a method of minimizing video data signals. Specific details of certain embodiments of the invention are set forth in the following description and Figures to provide a thorough understanding of such embodiments. One skilled in the art, however, will understand that other embodiments are possible, and that many embodiments may be practiced without several of the details described herein.

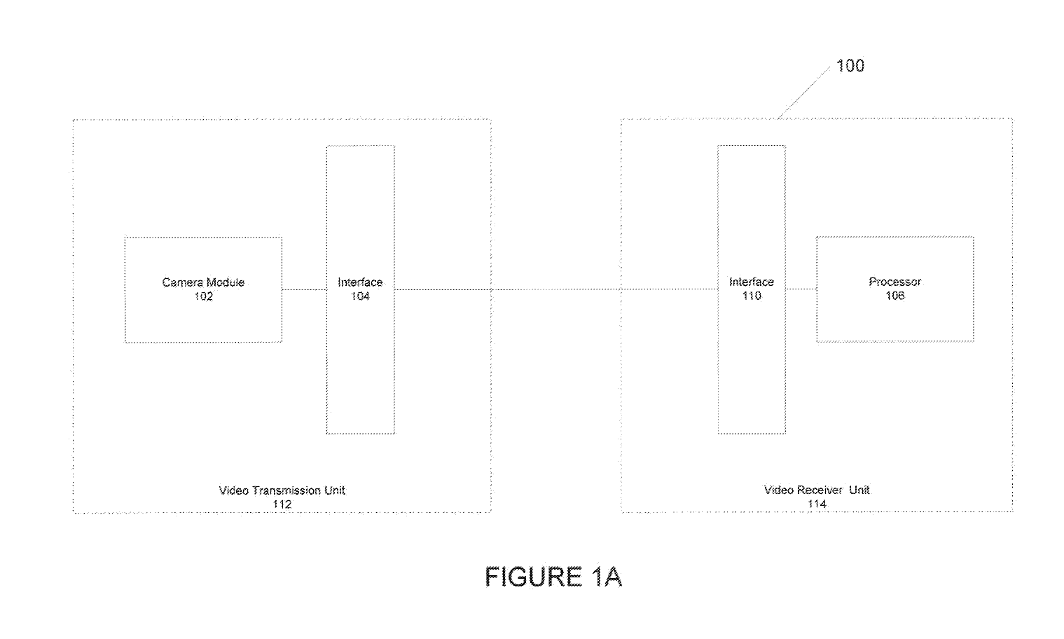

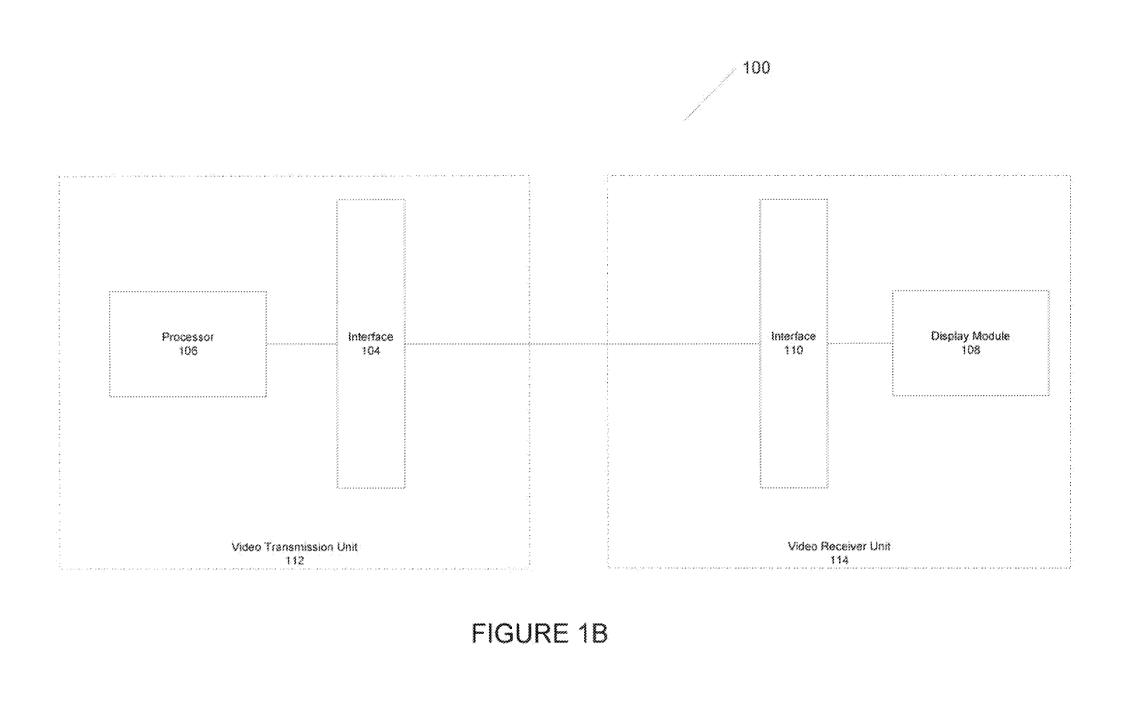

Referring to FIG. 1A, a diagram of an exemplary system for transmitting and receiving video data signals is depicted in accordance with one embodiment of the present disclosure. As shown in FIG. 1A, system 100 comprises a video transmission unit 112 for transmitting video signals and a video receiver unit 114 for receiving video signals. In this embodiment, video transmission unit 112 comprises a camera module 102 and an interface 104. The camera module 102 captures video data and sends traditional video data to the interface 104. Interface 104 then multiplexes the traditional video data and generates minimized video data before forwarding the minimized video data to interface 110.

Video receiver unit 114 receives minimized video data from the video transmission unit 112. In this embodiment, video receiver unit 114 comprises an interface 110 and a processor 106. In the context of the present disclosure, processor 106 may be any type of data processing unit or a source/sink for data. For example, processor 106 may be a display module, such as display module 108 in FIG. 1B, to which video data is sent to be displayed. Interface 110 receives minimized video data from interface 104 and de-multiplexes the minimized video data into traditional video data and sends the traditional video data to processor 106 for processing. It is noted that system 100 is shown in FIG. 1A for illustrative purpose only. Modules other than camera module 102 may be used to capture traditional video data without departing the spirit and scope of the present disclosure.

Referring to FIG. 1B, a diagram of an exemplary system for transmitting and receiving video data signals is depicted in accordance with an alternative embodiment of the present disclosure. As shown in FIG. 1B, system 100 comprises a video transmission unit 112 for transmitting video signals and a video receiver unit 114 for receiving video signals. In this embodiment, video transmission unit 112 comprises a processor 106 and an interface 104. The processor 106 processes and transmits traditional video data to the interface 104. Interface 104 then multiplexes the traditional video data and generates minimized video data before forwarding the minimized video data to interface 110.

Video receiver unit 114 receives minimized video data from the video transmission unit 112. In this embodiment, video receiver unit 114 comprises an interface 110 and a display module 108. Interface 110 receives minimized video data from interface 104 and de-multiplexes the minimized video data into traditional video data and sends the traditional video data to display module 108 for display. It is noted that system 100 is shown in FIG. 1B for illustrative purpose only. Modules other than display module 108 may be used to display traditional video data without departing the spirit and scope of the present disclosure.

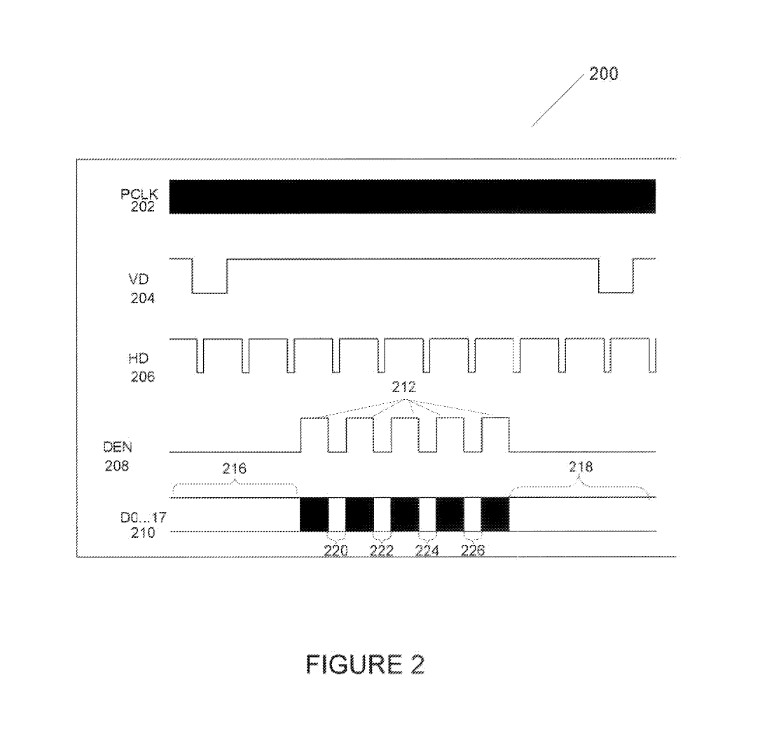

Referring to FIG. 2, a timing diagram of an exemplary parallel video interface before time multiplexing is depicted in accordance with one embodiment of the present disclosure. A video is a stream of frames with each frame being made up of a series of horizontal lines. Each horizontal line is made up of a series of pixels. Generally, the lines in each frame are transmitted in order from top to bottom and the pixels in each line are transmitted from left to right. Separate horizontal and/or vertical synchronization signals are used to define the ends of each line and frame.

In this embodiment, timing diagram 200 illustrates signals for video data communications before time multiplexing by interface 104 in about one frame. Interface 104 or 110 may be an 18-bit parallel interface for video data communication. However, interface 104 or 110 may be a parallel interface of other size without departing the spirit and scope of the present disclosure.

As illustrated in FIG. 2, timing diagram 200 includes a pixel clock PCLK 202, which provides a time reference for all of the other video signals. Pixel clock PCLK 202 oscillates very fast and is included in FIG. 2 for completeness of video data communication. Timing diagram 200 also includes a vertical synchronization signal VD 204 and a horizontal synchronization signal HD 206. Vertical synchronization signal VD 204 provides a pulse, typically an active low, at the start of each frame. For example, vertical synchronization signal VD 204 is low at the beginning of the current frame and the next frame (as illustrated by two active lows). Horizontal synchronization signal HD 206 provides a pulse, typically an active low, at the beginning of each line. In the frame as illustrated in timing diagram 200, there are nine active lows, which represent a total of nine lines for this frame.

Timing diagram 200 also includes a data enable signal DEN 208, which indicates a visible line when the signal is active (typically high). When the data enable signal DEN 208 is low, it represents a blanking line, which means that a line is invisible and no video data is enabled. In the frame as illustrated in timing diagram 200, there are five active lines that are visible (as illustrated by five active highs 212).

Timing diagram 200 further includes a vector for storing actual pixel data D 210. Because the interface in this embodiment is an 18-bit interface, the size of the pixel data vector D 210 is 18 bits starting from D0 to D17. However, pixel data vector D of other size may also be used without departing the spirit and scope of the present disclosure. Data elements outside of the active lines 212 are don't cares. In this example, data elements during time intervals 216, 218, 220, 222, 224, and 226 are don't cares because they are all outside of active lines 212.

From timing diagram 200, both VD 204 and HD 206 signals are inactive (typically high) when data enable signal DEN 208 is active (typically high). Thus, VD 204 and HD 206 are interesting only when data enable signal DEN 208 is inactive (low). This is the exact same time when data in pixel data vector D 210 is outside of active lines 212 or don't care, such as during time intervals 216, 218, 220, 222, 224, and 226. Therefore, data elements outside of active lines 212 in pixel data vector D 210 may be used for other purposes, such as carrying VD 204 and/or HD 206 signals during these intervals.

In one embodiment of the present disclosure, at least one data element of the pixel data vector D 210 may be used to carry VD or HD. For example, data element D0 and data element D1 of pixel data vector D 210 may be used to carry VD signal 204 and HD signal 206 respectively. However, any data element in the pixel data vector D 210 other than D0 and D1 may be used to carry VD signal 204 and HD signal 206 without departing the spirit and scope of the present disclosure. For example, data element D16 and D17 may be used to carry VD signal 204 and HD signal 206 as well.

As discussed above, both VD 204 and HD 206 signals may be time-multiplexed in data elements of pixel data vector D 210. In addition, either VD signal 204 or HD signal 206 may be time-multiplexed in any data element of pixel data vector D 210 such that VD signal 204 and HD 206 are treated independent of one another. For example, VD signal 204 may be carried in D0 of pixel data vector D 210 while HD signal 206 remains to be sent as a separate signal outside of pixel data vector D 210. Alternatively, HD signal 206 may be carried in D1 of pixel data vector D 210 while VD signal 204 remains to be sent as a separate signal outside of pixel data vector D 210.

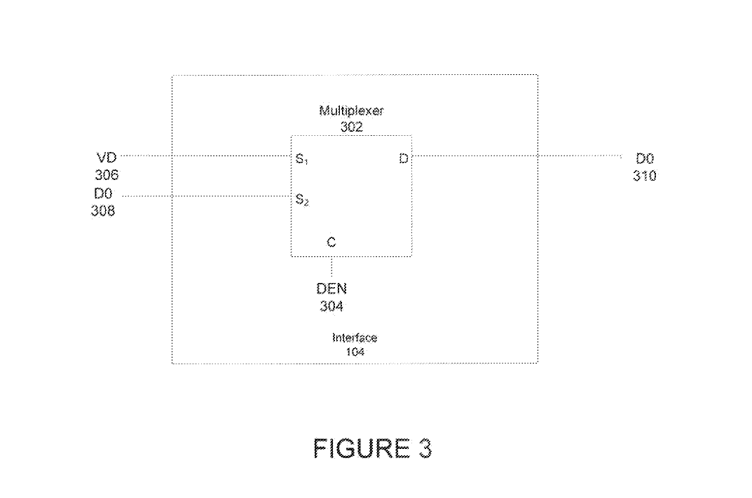

Referring to FIG. 3, a diagram illustrating an exemplary interface for multiplexing video data is depicted in accordance with one embodiment of the present disclosure. In this embodiment, only VD signal 306 is selected based on the data enable signal DEN 304. Interface 104 in video transmission unit 112 comprises a multiplexer 302 for selection of video data output. Multiplexer 302 is provided to select which signal is to be sent via pixel data vector D 210 based on a data enable signal, such as an signal sourcing pin DEN 304. For example, when DEN 304 is active, multiplexer 302 selects actual data D0 306 to be sent via pixel data vector D 208 as actual interface signal D0 310 because VD 306 is only interesting when DEN 304 is inactive. When DEN 304 is inactive, multiplexer 302 selects VD 306 to be sent via pixel data vector D 210 as actual interface signal D0 310. By allowing VD 306 to be sent via data element D0 310 of the pixel data vector D 210 when DEN 304 is inactive, the signal normally required for carrying VD 204 in interface 104 may be eliminated and thus reduces the number of video data input/output signals needed for transmission.

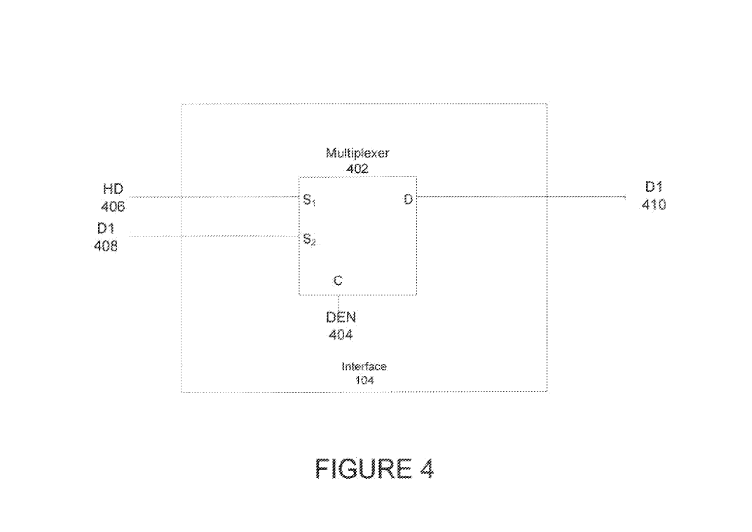

Referring to FIG. 4, a diagram illustrating an exemplary interface for multiplexing video data is depicted in accordance with an alternative embodiment of the present disclosure. In this embodiment, only HD signal 406 is selected based on the data enable signal DEN 404. Interface 104 in video transmission unit 112 comprises a multiplexer 402 for selection of video data output D1 410. Multiplexer 402 is provided to select which signal is to be sent via pixel data vector D 210 based on a data enable signal, such as an internal signal sourcing pin DEN 404.

When DEN 404 is inactive, multiplexer 402 selects HD 406 to be sent via data element D1 410 of the pixel data vector D 210. Thus, multiplexer 402 outputs HD 406 to D1 410 as actual interface data signal sent via pixel data vector D 210. When DEN 404 is active, multiplexer 402 selects actual data signal D1 408 to be sent via data element D1 410 of the pixel data vector D 210. Thus, multiplexer 402 outputs D1 408 as actual interface data signal sent via pixel data vector D 210. Data element D1 410 of pixel data vector D 210 is used here for illustrative purposes only. Data element other than D1 410 of pixel data vector D 210 may be used to carry HD and D1 without departing the spirit and scope of the present disclosure.

Thus, by sending VD 204 and HD 206 signals, either individually or in combination, via the pixel data vector D 210 while DEN 208 is inactive, the actual VD and HD signals in the interface 104 may be eliminated and thus reduces the number of input/output signals for video data communications.

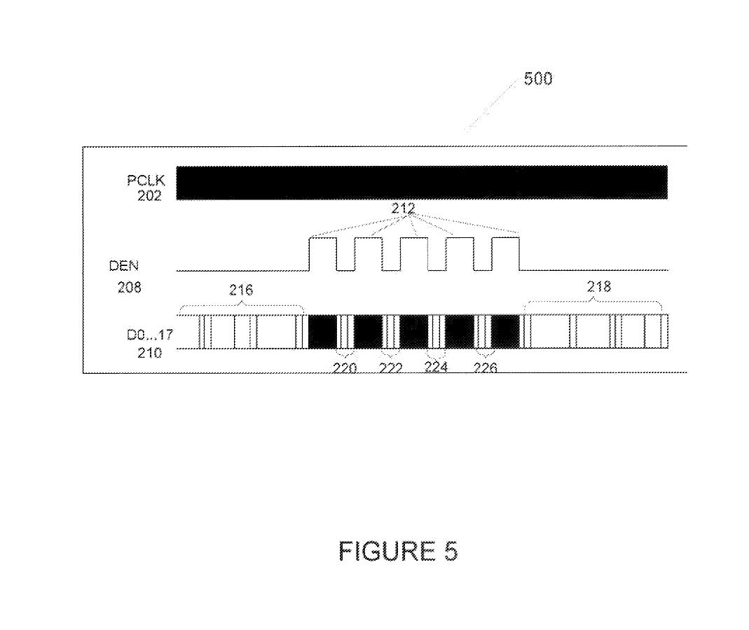

Referring to FIG. 5, a timing diagram of an exemplary interface after time multiplexing is depicted in accordance with one embodiment of the present disclosure. As shown in timing diagram 500, VD 204 and HD 206 signals may be carried in any data element of the pixel data vector D 210 when DEN 208 is inactive, such as during time intervals 216, 218, 220, 222, 224, and 226. For example, D0 may be used to carry VD signal 204 and D1 may be used to carry HD signal 206 and vice versa. In this way, VD signal 204 and HD signal 206 in interface 104 or 110 may be eliminated and the number of input/output signals for video data communication is reduced. This leads to a lower number of pins and wires required for data communications by interface 104 or 110.

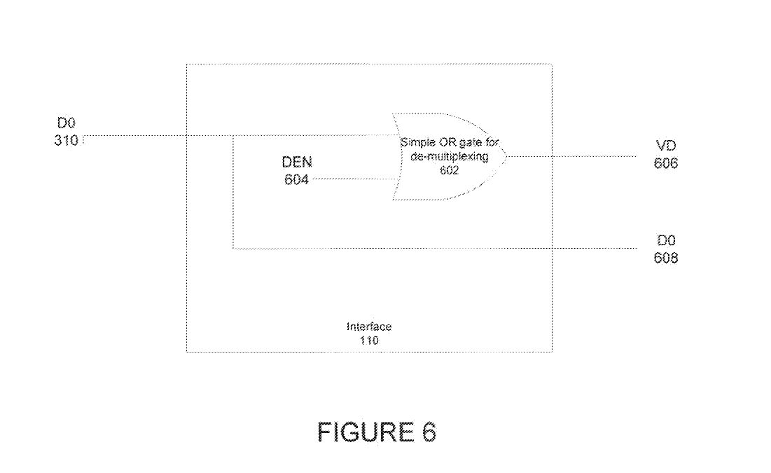

Referring to FIG. 6, a diagram illustrating an exemplary interface for de-multiplexing video data is depicted in accordance with one embodiment of the present disclosure. In this embodiment, interface 110 in video receiver unit 114 comprises a simple OR gate for de-multiplexing 602 which time de-multiplexes data input D0 310 of pixel data vector D 210. Simple OR gate for de-multiplexing 602 time de-multiplexes data signal received via pixel data vector D 210 based on a data enable signal, such as an signal sourcing pin DEN 604. In this embodiment, simple OR gate for de-multiplexing 602 works in conjunction with a typical low-active VD or HD signal. It is noted that modification of simple OR gate for de-multiplexing 602 may be necessary for other types of VD or HD signals.

In this embodiment, simple OR gate for de-multiplexing 602 is an OR gate that receives two input signals, actual data interface signal D0 310 from pixel data vector D 210 and DEN 604. If DEN 604 is inactive (low), simple OR gate for de-multiplexing 602 outputs D0 310 from the pixel data vector D 210 as the video signal VD 606. If DEN 604 is active (high), simple OR gate for de-multiplexing 602 outputs inactive (high) as the video signal VD 606. D0 310 is output from the pixel data vector D 210 as D0 608.

It is noted that simple OR gate for de-multiplexing 602 is shown here for illustrative purposes only. Other types of de-multiplexer may be used to time de-multiplex data signals received via pixel data vector D 210 based on a data enable signal without departing from the spirit and scope of the present disclosure. In addition to VD 606, similar implementation of simple OR gate for de-multiplexing 602 may be used to output HD signal as the video signal based on DEN 604. In that case, simple OR gate for de-multiplexing 602 outputs inactive (high) as the video signal HD 606 if DEN 604 is active (high).

In the above embodiment, interfaces 104 and 110 are implemented as part of an integrated circuit of video transmission unit 112 and video receiver unit 114. However, interfaces 104 or 110 may also be implemented outside of an integrated circuit of video transmission unit 112 and video receiver unit 114 without departing the spirit and scope of the present disclosure. In that case, VD, HD, D0, and D1 and other signals are not internal to the integrated circuit. The die area required for implementing interfaces 104 and 110 as illustrated in FIG. 3, FIG. 4 and FIG. 6 is minimal because of the low complexity of multiplexer 302, 402 and de-multiplexer 602. However, the number of signals required for the input/output of video data is greatly minimized due to the elimination of VD 204 and/or HD 206 signals.

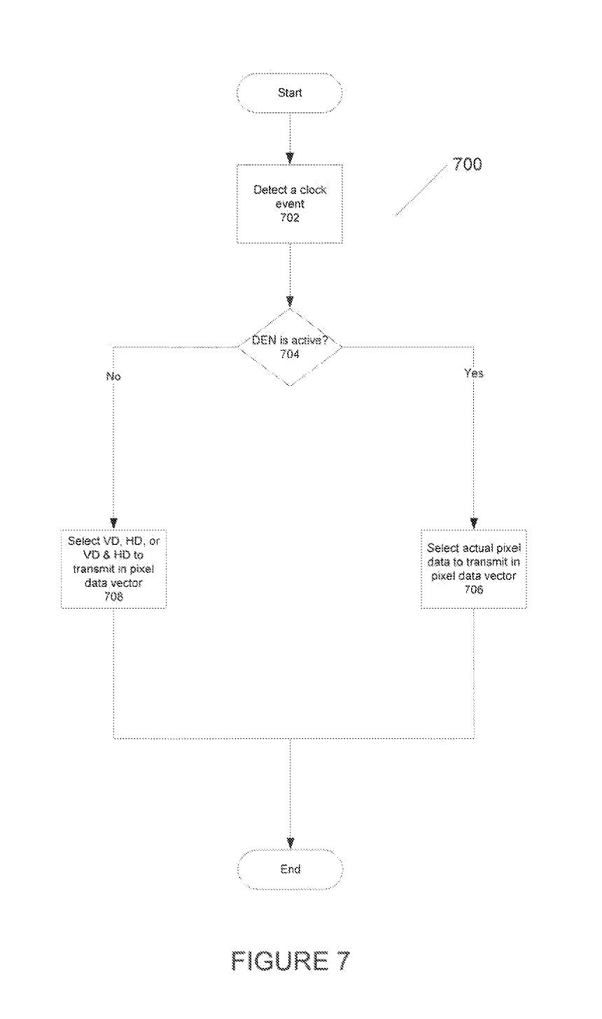

Referring to FIG. 7, a flowchart of an exemplary process for time-multiplexing of input signals of video data is depicted in accordance with one embodiment of the present disclosure. In this example, process 700 may be implemented in interface 104 of the video transmission unit 112. However, process 700 may be implemented in other types of video interface without departing the spirit and scope of the present disclosure.

Process 700 begins at step 702 to detect clock event, for example, a rising edge of the time reference clock PCLK 202. Upon detecting a clock event, process 700 proceeds to step 704 to determine if data enable signal DEN is active. If data enable signal DEN is not active, VD and/or HD signals are sent via data elements of the pixel data vector D 210. This double usage of data elements minimizes the number of signals needed for transmission.

If data enable signal DEN is active, process 700 proceeds to step 706 to select actual pixel data D0 or D1 to transmit as data element of pixel data vector D 210. However, if data enable signal DEN is not active, process 700 proceeds to step 708 to select a VD signal 204, a HD signal 206, or a combination of VD 204 and HD 206 signals to transmit as data elements of the pixel data vector D 210. In this way, signals normally required for carrying VD 204 and/or HD 206 in interface 104 may be eliminated and thus reduce the number of video data input/output signals needed for transmission.

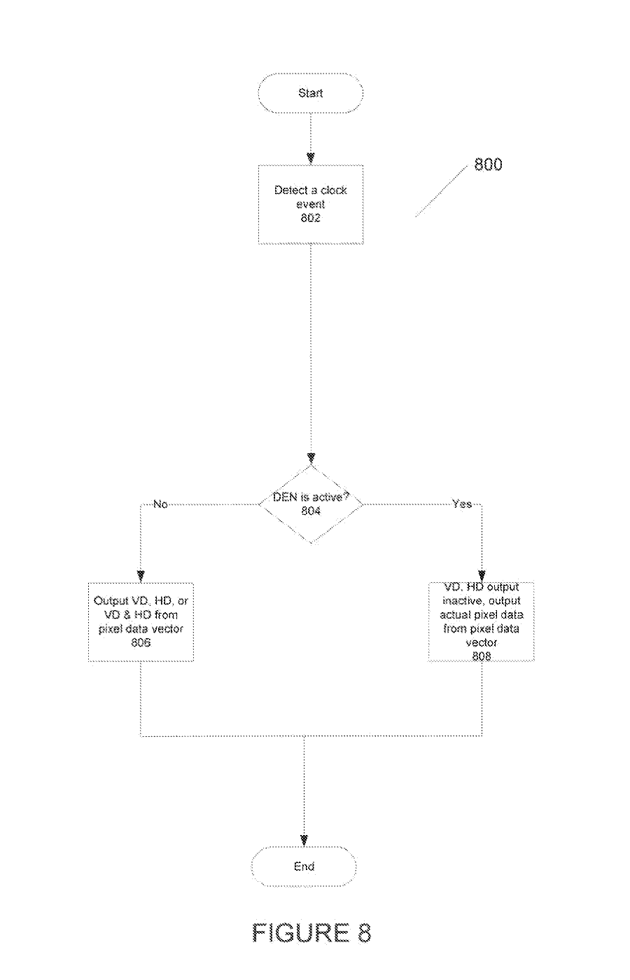

Referring to FIG. 8, a flowchart of an exemplary process for time-demultiplexing of input signals of video data is depicted in accordance with one embodiment of the present disclosure. In this example, process 800 may be implemented in interface 110 of the video receiver unit 114. However, process 800 may be implemented in other types of video interface without departing the spirit and scope of the present disclosure.

Process 800 begins at step 802 to detect a clock event, for example, a rising edge of a time reference clock PCLK 202. Upon detecting a clock event, process 800 proceeds to step 804 to determine if data enable signal DEN is active. If data enable signal DEN is not active, process 800 proceeds to step 806 to output a VD signal 204, a HD signal 206, or a combination of VD signal 204 and HD signal 206 from pixel data vector D 210. In one embodiment, step 804 may be performed by using a simple OR gate for de-multiplexing data elements of pixel data vector D 210, such as simple OR gate for de-multiplexing 602 in FIG. 6, based on data enable signal DEN 208. This means that the VD signal, HD signal or a combination of VD and HD signals are taken from the pixel data vector D 210 to minimize the number of video input signals for reception. If data enable signal DEN is active, VD and HD signals are output inactive (typically high) and process 800 proceeds to step 808 to output actual pixel data D0, D1 from pixel data vector D 210. It should be noted that the method described herein does not have to be executed in the order described. Moreover, various activities described with respect to the method can be executed in repetitive, simultaneous, serial, or parallel fashion.

What is claimed:

1. A system for minimizing signals for video data communication comprising:
a first interface for selecting at least one video signal for transmission via a video data vector based on a data enable signal; and
a second interface for outputting at least one video signal from the video data vector based on the data enable signal.

2. The system of claim 1, wherein the at least one video signal comprises a vertical synchronization signal, a horizontal synchronization signal, a combination of a vertical synchronization signal and a horizontal synchronization signal, and an actual video data.

3. The system of claim 1, wherein the video data vector comprises at least one data element for carrying the at least one video signal.

4. The system of claim 2, wherein the first interface comprises a multiplexer for selecting the vertical synchronization signal, the horizontal synchronization signal, or the combination of a vertical synchronization signal and a horizontal synchronization signal if the data enable signal is not active.

5. The system of claim 2, wherein the first interface comprises a multiplexer for selecting the actual video data if the data enable signal is active.

6. The system of claim 2, wherein the second interface comprises a de-multiplexer for outputting at least one video signal as the vertical synchronization signal, the horizontal synchronization signal, or the combination of a vertical synchronization signal and a horizontal synchronization signal if the data enable signal is not active.

7. The system of claim 2, wherein the second interface comprises a de-multiplexer for outputting an inactive high as the vertical synchronization signal, the horizontal synchronization signal, or the combination of a vertical synchronization signal, and the actual video data if the data enable signal is active.

8. The system of claim 3, wherein the at least one data element for carrying the at least one video signal comprises a first data element for carrying a vertical synchronization signal and a second element for carrying a horizontal synchronization signal.

9. A video interface comprising:
a multiplexer for selecting at least one video signal to transmit via a video data vector upon detecting a data enable signal.

10. The video interface of claim 9, wherein the multiplexer comprises at least one video data input connection, a data enable connection, and at least one video data output connection.

11. The video interface of claim 10, wherein the at least one video data input connection is adapted to receive a vertical synchronization signal, a horizontal synchronization signal, a combination of a vertical synchronization signal and a horizontal synchronization signal, and at least one actual video data.

12. The video interface of claim 9, wherein the video data vector comprises at least one data element carrying at least one of a vertical synchronization signal, a horizontal synchronization signal, or a combination of a vertical synchronization signal and a horizontal synchronization signal if the data enable signal is not active.

13. The video interface of claim 9, wherein the video data vector comprises at least one data element carrying at least one actual video data if the data enable signal is active.

14. A video interface comprising:
a de-multiplexer for outputting at least one video signal from a video data vector upon detecting a data enable signal.

15. The video interface of claim 14, wherein the de-multiplexer comprises at least one video data vector connection, at least one video output connection, and a data enable connection.

16. The video interface of claim 15, wherein the at least one video data vector connection is adapted to receive the video data vector, wherein the video data vector comprises at least one data element carrying at least one of a vertical synchronization signal, a horizontal synchronization signal, a combination of a vertical synchronization signal and a horizontal synchronization signal, or at least one actual video data.

17. The video interface of claim 15, wherein the at least one video data output connection is adapted to output at least one data element as a vertical synchronization signal, a horizontal synchronization signal, or a combination of a vertical synchronization signal and a horizontal synchronization signal if the data enable signal is not active.

18. The video interface of claim 15, wherein the at least one video data output connection is adapted to output an inactive high as a vertical synchronization signal, a horizontal synchronization signal, or a combination of a vertical synchronization signal and a horizontal synchronization signal, and at least one actual video data if the data enable signal is active.

19. A method for minimizing signals for video data communications comprising:
detecting at least one video input signal comprising at least one synchronization signal and at least one actual video data; and
transmitting one of the at least one synchronization signal and the at least one actual video data via a video data vector based on a data enable signal.

20. The method of claim 19, wherein transmitting one of the at least one synchronization signal and the at least one actual video data via a video data vector based on a data enable signal comprises:
determining if the data enable signal is active; and
transmitting the at least one synchronization signal via the video data vector if the data enable signal is not active.

21. The method of claim 19, wherein transmitting one of the at least one synchronization signal and the at least one actual video data via a video data vector based on a data enable signal comprises:
determining if the data enable signal is active; and
transmitting the at least one actual video data via the video data vector if the data enable signal is active.

22. The method of claim 19, wherein transmitting one of the at least one synchronization signal and the at least one actual video data via a video data vector based on a data enable signal comprises:
transmitting the at least one synchronization signal and the at least one actual video data as at least one data element in the video data vector.

23. The method of claim 22, wherein transmitting the at least one synchronization signal via the video data vector if the data enable signal is not active comprises transmitting a vertical synchronization signal, a horizontal synchronization signal, or a combination of a vertical synchronization signal and a horizontal synchronization signal as the at least one data element if the data enable signal is not active.

24. The method of claim 19, further comprising:
receiving a video data vector; and
outputting one of at least one synchronization signal and at least one actual video data from the video data vector based on the data enable signal.

25. The method of claim 24, wherein outputting one of the at least one synchronization signal and at least one actual video data from the video data vector based on a data enable signal comprises:
outputting at least one data element of the video data vector as the at least one synchronization signal if the data enable signal is not active; and
outputting at least one data element of the video data vector as the at least one actual video data if the data enable signal is active and the at least one synchronization signal is output inactive.
